(19) United States
(12) Patent Application Publication
(10) Pub. No.: US 2005/0259110 A1
(43) Pub. Date: Nov. 24, 2005

(54) Multiple color transformation apparatus, method of forming image, and a computer-readable recording medium storing computer program

(75) Inventors: Wonhee Choe, Gyeongju-si (KR); Hyunwook Ok, Yongin-si (KR); Seongdeok Lee, Suwon-si (KR); Changveong Kim, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/116,437

(22) Filed: Apr. 28, 2005

(30) Foreign Application Priority Data
Apr. 30, 2004 (KR) 10-2004-0030651
Mar. 2, 2005 (KR) 10-2005-0017221

(51) Int. Cl. G09G 5/02

(52) U.S. Cl. 345/591; 345/604

(57) ABSTRACT

A multiple color transformation apparatus and method for an image and a computer readable recording medium storing a computer program therefore are provided. The multiple color transformation apparatus includes a middle status chrominance component producer which linearly combines first through M^{th} (where M is a positive integer larger than “3”) input chrominance components to represent a color of each of pixels of the image to produce first through N^{th} (where N is greater than or equal to M) middle status chrominance components; and a chrominance component compensator which relatively differently adjusts luminance levels of the first through N^{th} middle status chrominance components according to degrees to which the first through N^{th} middle status chrominance components contribute to representing a single color and outputs the first through N^{th} middle status chrominance components having the adjusted luminance levels as color-compensated first through N^{th} middle status chrominance components. Therefore, using the multiple color transformation apparatus and method, a number of input chrominance components can be transformed into a variety of chrominance components while maximizing a luminance and color saturation of an image display device.

### CROSS-REFERENCE TO RELATED APPLICATIONS

This application claims the priority of Korean Patent Application No. 10-2004-30651, filed on Apr. 30, 2004, and No. 10-2005-17221, filed on Mar. 2, 2005, in the Korean Intellectual Property Office, the disclosures of which are incorporated herein in their entirety by reference.

### BACKGROUND OF THE INVENTION

1. Field of the Invention

The present invention relates to processing of an image to display the image in multiple primary colors, and more particularly, to a multiple color transformation apparatus and method for forming an image and a computer-readable recording medium using the same.

2. Description of the Related Art

In general, an image signal is processed in a 3-dimensional color space where red (R), green (G), and blue (B) colors are representative. Also, an image corresponding to the image signal is displayed via a display device using three color light sources. It is possible for the image signal to be displayed using R, G, and B chrominance components due to the fact that R, G, and B colors are primary colors that can be used for forming all other colors.

FIG. 1 is a view for showing the relationships among primary colors. Referring to FIG. 1, all kinds of colors may be represented with combinations of three primary colors R, G, and B. For example, a combination of R and G makes yellow (Y), a combination of G and B makes cyan (C), and a combination of B and R makes magenta (M). Also, a combination of three primary colors R, G, and B forms white (W).

FIG. 2 is a view for showing the relationships among wavelengths of R, G, B, C, M, and Y chrominance components. Referring to FIG. 2, an R chrominance component has the longest wavelength, while a B chrominance component has the shortest wavelength. A wavelength of a Y chrominance component is about half the sum of wavelengths of G and R chrominance components, a wavelength of a C chrominance component is about half the sum of the wavelengths of G and B chrominance components, and a wavelength of an M chrominance component is about half the sum of the wavelengths of B and R chrominance components. Therefore, a combination of two different primary chrominance components can result in obtaining C, M, and Y chrominance components.

FIG. 3 is a view for showing chromaticity coordinates of R, G, B, C, M, and Y chrominance components. Referring to FIG. 3, a chromaticity coordinate system can be simplified by overlapping an RGB triangle having R, G, and B apexes with a CMY triangle having C, M, and Y apexes. In this case, all chromaticity coordinates within the RGB triangle can be expressed with combinations of R, G, and B chrominance components. Also, all chromaticity coordinates within the CMY triangle can be expressed with combinations of C, M, and Y chrominance components. However, chromaticity coordinates outside the RGB and CMY triangles cannot be expressed with combinations of chrominance components constituting their apexes. For example, chromaticity coordinates outside the RGB triangle (marked with slanted lines) cannot be expressed with only the R, G, and B chrominance components. As a result, a larger number of light sources must be used to express a wider color gamut. A plurality of conventional multiple color transformation methods of transforming a number of input chrominance components into a variety of chrominance components are used to express a clearer and more realistic image.

One of the conventional multiple color transformation methods is disclosed in U.S. Pat. No. 6,633,302 assigned to Olympus Optical Co., Ltd. In a case where the disclosed multiple color transformation method is applied to a five-or-more-primary-color system, the segmentation of a color space becomes very complicated. Thus, the disclosed multiple color transformation method has difficulty in being realized.

Another conventional multiple color transformation method is disclosed in WO 02/101644 applied to by Genoa Color Technologies Ltd. The disclosed multiple color transformation method requires a complicated process of calculating a lookup table (LUT).

Moreover, maximum color saturation and a maximum luminance value, which can be expressed by an image display device, vary according to a used conventional multiple color transformation method. As a result, the quality of an output image may be deteriorated.

### SUMMARY OF THE INVENTION

Accordingly, it is an aspect of the present invention to overcome the foregoing and/or other disadvantages of the conventional designs.

Additional aspects and/or advantages of the invention will be set forth in part in the description which follows and, in part, will be obvious from the description, or may be learned by practice of the invention.

It is an aspect of the present invention to provide a multiple color transformation apparatus for an image to simply transform a number of input chrominance components into a variety of chrominance components while minimizing deterioration of image quality.

It is another aspect of the present invention to provide a multiple color transformation method for an image to simply transform a number of input chrominance components into a variety of chrominance components while minimizing deterioration of image quality.

It is another aspect of the present invention to provide a computer readable recording medium storing a computer program to simply transform a number of input chrominance components into a variety of chrominance components while minimizing deterioration of image quality.

The foregoing and/or other aspects may be achieved by providing a multiple color transformation apparatus for an image, including: a middle status chrominance component producer which linearly combines first through M^{th} (where M is a positive integer greater than or equal to “3”) input chrominance components to represent a color of each of the pixels to thereby produce first through N^{th} (where N is greater than or equal to M) middle status chrominance components; and a chrominance component compensator which relatively differently adjusts luminance levels of the first through N^{th} middle status chrominance components according to degrees to which the first through N^{th} middle status chrominance components contribute to representing a single color of the image and outputs the first through N^{th} middle status chrominance components having the adjusted luminance levels as color-compensated first through N^{th} middle status chrominance components.

The foregoing and/or other aspects may also be achieved by providing a multiple color transformation apparatus including: a middle status chrominance component producer which linearly combines first through M^{th} (where M is a positive integer greater than or equal to “3”) input chrominance components to represent a color of each of pixels of the image to produce first through N^{th} (where N is greater than or equal to M) middle status chrominance components; and a luminance component compensator which compensates luminance levels of the first through N^{th} middle status chrominance components by a difference between a luminance level of a single color to be represented by the first through N^{th} middle status chrominance components and a compensation level.

The foregoing and/or other aspects may also be achieved by providing a multiple color transformation method for an image, including: producing first through N^{th} middle status chrominance components by linearly combining first through M^{th} (where M is a positive integer greater than or equal to 3and N is greater than or equal to M) input chrominance components for representing a color of each of pixels of the image; and relatively differently adjusting luminance levels of the first through N^{th} middle status chrominance components according to degrees to which the first through N^{th} middle status chrominance components contribute to representing a single color of the image and determining the first through N^{th} middle status chrominance components having the adjusted luminance levels as color-compensated first through N^{th} middle status chrominance components.

The foregoing and/or other aspects may also be achieved by providing a multiple color transformation method including: linearly combining first through M^{th} (where M is a positive integer greater than or equal to 3) input chrominance components for representing a color of each of pixels of the image to produce first through N^{th} (where N is greater than or equal to M) middle status chrominance components; and compensating luminance levels of the first through N^{th} middle status chrominance components by a difference between a luminance level of a single color to be represented by the first through N^{th} middle status chrominance components and a compensation level.

The forgoing and/or other aspects may also be achieved by providing a computer readable recording medium storing a computer program for a multiple color transformation method for an image, the method including: producing first through N^{th} middle status chrominance components by linearly combining first through M^{th} (where M is a positive integer greater than or equal to 3 and N is greater than or equal to M) input chrominance components for representing a color of each of pixels of the image; and relatively differently adjusting luminance levels of the first through N^{th} middle status chrominance components according to degrees to which the first through N^{th} middle status chrominance components contribute to representing a single color of the image and determining the first through N^{th} middle status chrominance components having the adjusted luminance levels as color-compensated first through N^{th} middle status chrominance components.

The forgoing and/or other aspects may also be achieved by providing a computer readable recording medium storing a computer program for a multiple color transformation method for an image, the method including: linearly combining first through M^{th} (where M is a positive integer greater than or equal to 3) input chrominance components for representing a color of each of pixels of the image to produce first through N^{th} (where N is greater than or equal to M) middle status chrominance components; and compensating luminance levels of the first through N^{th} middle status chrominance components by a difference between a luminance level of a single color to be represented by the first through N^{th} middle status chrominance components and a compensation level.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view for showing the relationships among primary colors;

FIG. 2 is a view for showing the relationships among wavelengths of R, G, B, C, M, and Y chrominance components;

FIG. 3 is a view for showing chromaticity coordinates of R, G, B, C, M, and Y chrominance components;

FIG. 4 is a block diagram of a multiple color transformation apparatus for an image, according to an embodiment of the present invention;

FIG. 5 is a flowchart for explaining a multiple color transformation method for an image, according to an embodiment of the present invention;

FIG. 6 is a block diagram of the middle status chrominance component producer of FIG. 4;

FIG. 7 is a graph for showing an exemplary relationship between a scaling ratio and grayness according to the present embodiments;

FIG. 8 is a block diagram of the middle status chrominance component producer of FIG. 4 according to another embodiment of the invention;

FIG. 9 is a block diagram of still another embodiment of the middle status chrominance component producer of FIG. 4 according to another embodiment of the invention;

FIG. 10 is a block diagram of the chrominance component compensator of FIG. 4;

FIG. 11 is a block diagram of the luminance component compensator of FIG. 4;

FIG. 12 is a block diagram of a multiple color transformation apparatus for an image according to another embodiment of the present invention; and

FIG. 13 is a flowchart of a multiple color transformation method for an image according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 4 is a block diagram of a multiple color transformation apparatus for an image, according to an embodiment of the present invention. Referring to FIG. 4, the multiple color transformation apparatus includes a middle status chrominance component producer 10, a chrominance component compensator 12, and a luminance component compensator 14.

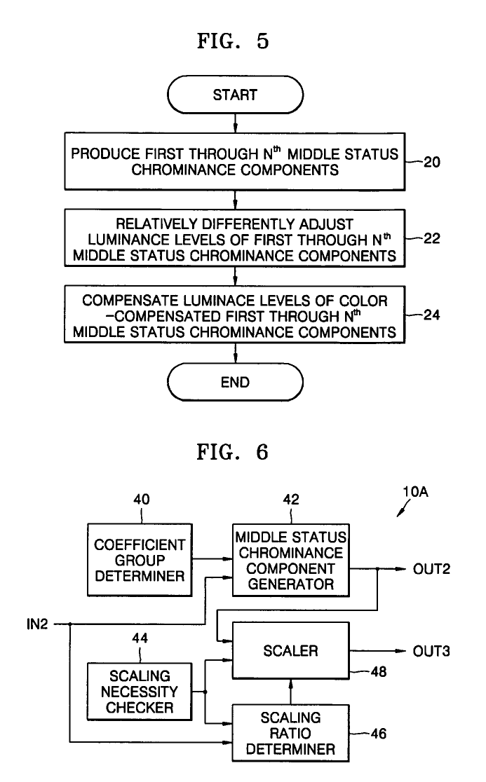

FIG. 5 is a flowchart for explaining a multiple color transformation method for an image, according to the embodiment of the present invention of FIG. 4. The multiple color transformation method includes operations 20 and 22 of respectively producing and compensating first through N^{th} middle status chrominance components and operation 24 of compensating luminance components of the color-compensated first through N^{th} middle status chrominance components.

In the embodiment of the present invention, the middle status chrominance component producer 10 of FIG. 4 receives first through M^{th} input chrominance components to represent a color of each of pixels of an image, via an input node IN1, linearly combines the first through M^{th} input chrominance components, and outputs the linear combination results as first through N^{th} middle status chrominance components to the chrominance component compensator 12 (operation 20). Here, M may be a positive integer greater than or equal to 3, and N may be greater than or equal to M. In other words, N may also be a positive integer greater than or equal to 3.

For example, in a case where the first through M^{th} input chrominance components are R, G, and B chrominance components, respectively, and the first through N^{th} middle status chrominance components are R, G, B, C, M, and Y chrominance components, respectively, the middle status chrominance component producer 10 may directly determine first through M input chrominance components Rᵢ, Gᵢ, and Bᵢ as first through third middle status chrominance components R₁, G₁, and B₁ and produce fourth through sixth middle status chrominance components C₁, M₁, and Y₁ from the first through third input chrominance components Rᵢ, Gᵢ, and Bᵢ using Equation 1:

$${C}_{1} = \frac{1}{2} ( {G}_{i} + {B}_{i} ) \\ {M}_{1} = \frac{1}{2} ( {R}_{i} + {B}_{i} ) \\ {Y}_{1} = \frac{1}{2} ( {R}_{i} + {G}_{i} ) \qquad ( 1 )$$

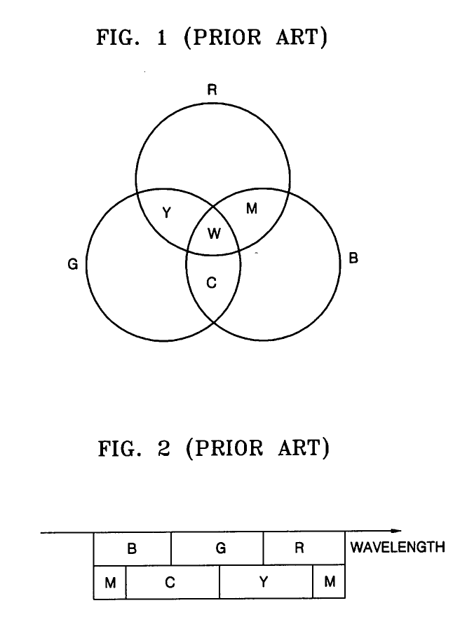

Equation 1 may be obtained from the relationships among chrominance components shown in FIGS. 1 and 2.

FIG. 6 is a block diagram of an embodiment 10A of the present invention of the middle status chrominance component producer 10 of FIG. 4, including a coefficient group determiner 40, a middle status chrominance component generator 42, a scaling necessity checker 44, a scaling ratio determiner 46, and a scaler 48.

According to an aspect of the present invention, unlike FIG. 6, the middle status chrominance component producer 10 may include only the coefficient group determiner 40 and the middle status chrominance component generator 42.

In this case, the coefficient group determiner 40 determines at least one coefficient group and outputs the determined coefficient group to the middle status chrominance component generator 42. Here, the middle status chrominance component generator 42 generates first through N^{th} middle status chrominance components using first through M^{th} input chrominance components, which are input via an input node IN2, and the coefficient group determined by the coefficient group determiner 40 and outputs the generated first through N^{th} middle status chrominance components via an output node OUT2.

For example, when the first through M^{th} input chrominance components are denoted by Cl₁, Cl₂, . . . , and Cl_{M}, and the first through N^{th} middle status chrominance components output from the middle status chrominance component producer 10 are denoted by CM₁, CM₂, . . . , and CM_{M}, the first through N^{th} middle status chrominance components can be obtained using Equation 2:

$$[ \begin{matrix}{CM}_{1} \\ {CM}_{2} \\ ⋮ \\ {CM}_{M}\end{matrix} ] = {COEFF}_{1} [ \begin{matrix}{CI}_{1} \\ {CI}_{2} \\ ⋮ \\ {CI}_{M}\end{matrix} ] , [ \begin{matrix}{CM}_{M + 1} \\ {CM}_{M + 2} \\ ⋮ \\ {CM}_{N}\end{matrix} ] = {COEFF}_{2} [ \begin{matrix}{CI}_{1} \\ {CI}_{2} \\ ⋮ \\ {CI}_{M}\end{matrix} ] \qquad ( 2 )$$

wherein COEFF₁, and COEFF₂ denote a first coefficient group and a second coefficient group, respectively, which are determined by the coefficient group determiner 40. When M=3 and Cl₁, Cl₂, and Cl₃ are Rᵢ, Gᵢ, and Bᵢ, respectively, and when N=6 and CM₁, CM₂, CM₃, CM₄, CM₅, and CM₆ are R₁, G₁, B₁, C₁, M₁, and Y₁, respectively, Equation 2 can be expressed as Equation 3:

$$[ \begin{matrix}{R}_{1} \\ {G}_{1} \\ {B}_{1}\end{matrix} ] = [ \begin{matrix}a1b1c1 \\ d1e1f1 \\ g1h1i1\end{matrix} ] [ \begin{matrix}{R}_{i} \\ {G}_{i} \\ {B}_{i}\end{matrix} ] , [ \begin{matrix}{C}_{1} \\ {M}_{1} \\ {Y}_{1}\end{matrix} ] = [ \begin{matrix}a2b2c2 \\ d2e2f2 \\ g2h2i2\end{matrix} ] [ \begin{matrix}{R}_{i} \\ {G}_{i} \\ {B}_{i}\end{matrix} ] \qquad ( 3 )$$

wherein

$$[ \begin{matrix}a1b1c1 \\ d1e1f1 \\ g1h1i1\end{matrix} ]$$

denotes a first coefficient group, and

$$[ \begin{matrix}a2b2c2 \\ d2e2f2 \\ g2h2i2\end{matrix} ]$$

denotes a second coefficient group.

When M=3 and Cl₁, Cl₂, and Cl₃ are Rᵢ, Gᵢ, and Bᵢ, respectively, and when N=3 and CM₁, CM₂, and CM₃ are arbitrary among R₁, G₁, B₁, C₁, M₁, and Y₁, CM₁, CM₂, and CM₃ can be obtained according to Equation 3.

If an image display device (not shown) does not have a process capability, then (a₁, b₁, c₁)=(1, 0, 0), (d1, e1, f1)=(0, 1, 0), (g1, h1, i1)=(0, 0, 1), (a2, b2, c2)=(−1, 1, 1), (d2, e2, f2)=(1, −1, 1), and (g2, h2, i2)=(1, 1, −1). In a case where the process capability is no considered, then (a2, b2, c2)=(0, ½, ½), (d1, e1, f1)=(½, 0, ½), and (g1, h1, i1)=(½, ½, 0). Thus, the middle status chrominance component producer 10 according to an embodiment of the present invention may determine the first and second coefficient groups in consideration of the process capability.

According to another aspect of the present invention, as shown in FIG. 6, the middle status chrominance component producer 10 may further include the scaling necessity checker 44, the scaling ratio determiner 46, and the scaler 48.

The scaling necessity checker 44 of FIG. 6 checks whether a user requires scaling of at least one of the first through N^{th} middle status chrominance components and outputs the checked result to the scaling ratio determiner 46 and the scaler 48. Here, when the first through N^{th} middle status chrominance components have an undesired luminance level or the first through N^{th} middle status chrominance components have unsuitable color saturations, the user requests scaling of at least one of the first through N^{th} middle status chrominance components.

The scaling ratio determiner 46 determines a scaling ratio in response to the check result of the scaling necessity checker 44 and outputs the determined scaling ratio to the scaler 48. For example, if it is determined from the check result of the scaling necessity checker 44 that the user has requested scaling of at least one of the first through N^{th} middle status chrominance components, the scaling ratio determiner 46 determines the scaling ratio. According to the embodiment of the present invention, the scaling ratio determiner 46 determines the scaling ratio to be complementary to grayness of the first through M^{th} input chrominance components input via the input node IN2. For example, the scaling ratio determiner 46 can determine the scaling ratio using Equation 4:
n′=1−p×m (4)
wherein n′ denotes the scaling ratio, p denotes a predetermined constant, 0<p<1, and m denotes grayness which can be expressed as in Equation 5.

$$m = \frac{max ( {X1}_{i} , {X2}_{i} , … {XM}_{i} ) - min ( {X1}_{i} , {X2}_{i} , … {XM}_{i} )}{max ( {X1}_{i} , {X2}_{i} , … {XM}_{i} )} \qquad ( 5 )$$

wherein max(X1ᵢ,X2ᵢ, . . . XMᵢ) denotes maximum values of luminance levels (X1ᵢ, X2ᵢ, . . . , and XMᵢ) of the first through M^{th} input chrominance components, and min(X1ᵢ,X₂ᵢ, . . . XMᵢ) denotes minimum values of the luminance levels (X1ⱼ, X2ᵢ, . . . , and XMᵢ) of the first through M^{th} input chrominance components.

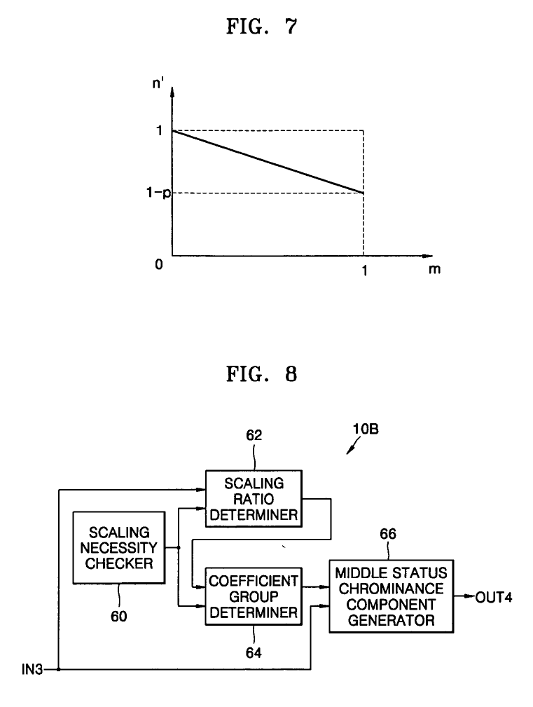

FIG. 7 is a graph for showing an exemplary relationship between a scaling ratio and grayness. Here, the horizontal axis denotes grayness m, and the vertical axis denotes the scaling ratio n′.

As shown in FIG. 7, in a case where the grayness m increases within a range between “0” and “1”, the scaling ratio n′ varies within a range between “1” and “1-p”. For example, when p=0.5, the scaling ratio n′ linearly decreases from “1” to “0.5.”

If it is perceived based on the check result of the scaling necessity checker 44 that the user has requested scaling of at least one of the first through N^{th} middle status chrominance components, for example, since at least one of the first through N^{th} middle status chrominance components has an undesired luminance level, the scaler 48 of FIG. 6 scales the at least one of the first through N^{th} middle status chrominance components using the scaling ratio determined by the scaling determiner 46 and outputs the scaled result via an output node OUT3.

For example, when color saturations of the first through N^{th} middle status chrominance components increase with increases in color saturations of M+1^{th} through N^{th} middle status chrominance components, the scaler 48 scales the first through N^{th} middle status chrominance components using the scaling ratio that is complementary to grayness, as shown in FIG. 7. This may result in reducing color saturations of first through N^{th} neutral color signals.

When a color (hereinafter referred to as a single color) to be represented by the first through N^{th} middle status chrominance components are achromatic, the scaler 48 of FIG. 6 scales all of the first through N^{th} middle status chrominance components, for example, R, G, B, C, M, and Y middle status chrominance components. When the single color to be represented by the first through N^{th} middle status chrominance components are chromatic, the scaler 48 scales only corresponding middle status chrominance components of the first through N^{th} middle status chrominance components, for example, C, M, and Y middle status chrominance components.

FIG. 8 is a block diagram of another embodiment 10B of the present invention of the middle status chrominance component producer 10 of FIG. 4, including a scaling necessity checker 60, a scaling ratio determiner 62, a coefficient group determiner 64, and a middle status chrominance component generator 66.

The scaling necessity checker 60 of FIG. 8 checks whether a user requests scaling of at least one of first through N^{th} middle status chrominance components and outputs the check result to the scaling ratio determiner 62 and the coefficient group determiner 64.

Here, if it is determined from the check result of the scaling necessity checker 60 that the user has requested scaling of at least one of the first through N^{th} middle status chrominance components, the scaling ratio determiner 62 determines a scaling ratio using first through M^{th} chrominance components, which are input via an input node IN3, for example, as in Equation 4 above, and outputs the determined scaling ratio to the coefficient group determiner 64. If it is determined from the check result of the scaling necessity checker 60 that the user has requested scaling of at least one of the first through N^{th} middle status chrominance components, the coefficient group determiner 64 determines at least one coefficient group in consideration of the scaling ratio input from the scaling ratio determiner 62 and outputs the determined at least one coefficient group to the middle status chrominance component generator 66.

If it is perceived based the check result of the scaling necessity checker 60 that the user has requested scaling of at least one of the first through N^{th} middle status chrominance components, for example, since at least one of luminance levels of the first through N^{th} middle status chrominance components is not a desired level, the coefficient group determiner 64 determines at least one coefficient group using the scaling ratio input from the scaling ratio determiner 62. For example, when color saturations of the first through N^{th} middle status chrominance components increase with increases in color saturations of M+1^{th} through N^{th} middle status chrominance components, the coefficient group determiner 64 determines at least one coefficient group in consideration of the scaling ratio so as to reduce color saturations of first through N^{th} neutral color signals.

When a single color to be represented by the first through N^{th} middle status chrominance components is achromatic, the coefficient group determiner 64 of FIG. 8 determines a coefficient group so as to scale all of first through N^{th} middle status chrominance components, which are to be generated by the middle status chrominance component generator 66, for example, R, G, B, C, M, and Y middle status chrominance components. When the single color to be represented by the first through N^{th} middle status chrominance components is chromatic, the coefficient group determiner 64 determines a coefficient group so as to scale corresponding middle status chrominance components of the first through N^{th} middle status chrominance components, for example, C, M, and Y middle status chrominance components.

The middle status chrominance component generator 66 of FIG. 8 generates the first through N^{th} middle status chrominance components using the first through M^{th} input chrominance components input via the input node IN3 and the coefficient group determined by the coefficient group determiner 64 and outputs the generated first through N^{th} middle status chrominance components via an output node OUT4.

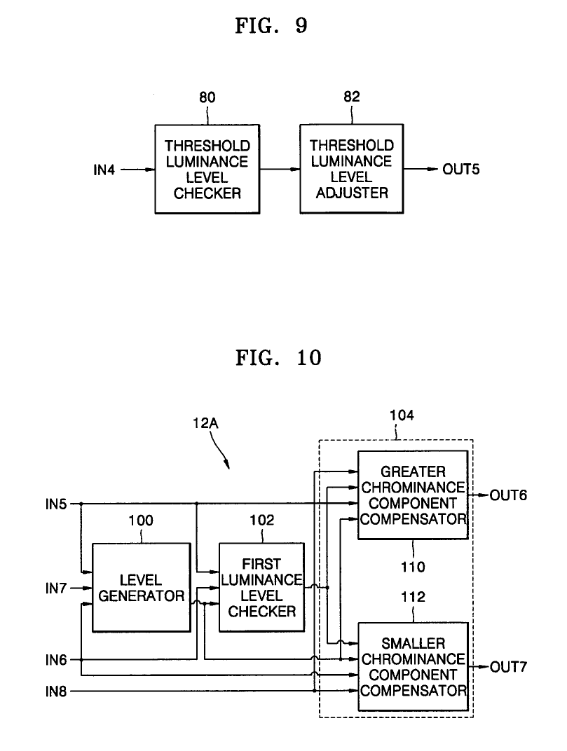

FIG. 9 is a block diagram of still another embodiment of the present invention of the middle status chrominance component producer 10 of FIG. 4, including a threshold luminance level checker 80 and a threshold luminance level adjuster 82.

According to another aspect of the present invention, the middle status chrominance component producer 10A of FIG. 6 or 10B of FIG. 8 may further include the threshold luminance level checker 80 and the threshold luminance level adjuster 82.

The threshold luminance level checker 80 checks whether at least one of luminance levels of scaled first through N^{th} middle status chrominance components input via an input node IN4 is out of a substantial threshold luminance level range and outputs the check result to the threshold luminance level adjuster 82. Here, the substantial threshold luminance level range refers to a luminance level range which can be substantially represented by a display device. For example, scaled luminance levels of the first through N^{th} middle status chrominance components may be negative luminance levels. In this case, the negative luminance levels refer not to luminance levels to be substantially represented by the display device but to theoretical luminance levels and thus exceed the threshold luminance level range.

If it is determined from the check result of the threshold luminance level checker 80 that the at least one of the luminance levels of the first through N^{th} middle status chrominance components is out of the substantial threshold luminance level range, the threshold luminance level adjuster 82 adjusts the at least one luminance level so as to be within the threshold luminance level range and outputs the adjustment result to the chrominance component compensator 12 via an output node OUT5.

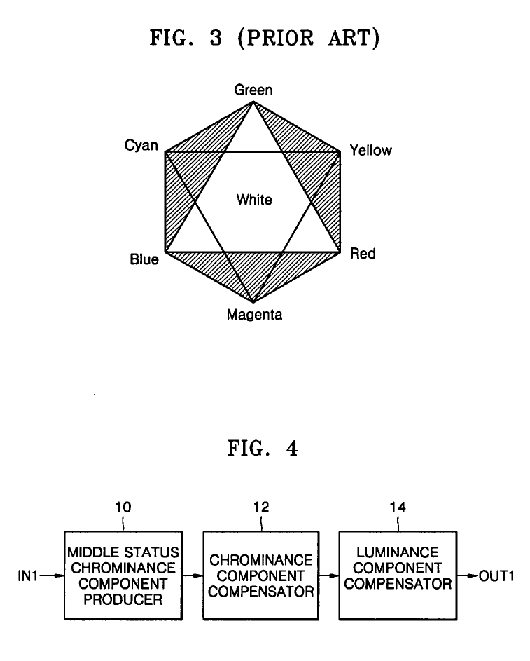

For example, the threshold luminance level checker 80 and the threshold luminance level adjuster 82 of FIG. 9 serve to express color areas which correspond to portions marked with slanted lines of FIG. 3 and which cannot be represented with three primary colors.

According to another embodiment of the present invention, the middle status chrominance component producer 10 in FIG. 4 receives, via an input node IN1, first through M^{th} input chrominance components Cl₁, Cl₂, . . . , and Cl_{M} for representing a color of each of pixels of the image, linearly combines the first through M^{th} input chrominance components Cl₁, Cl₂, . . . , and Cl_{M}, and outputs the result of the linear combination as first through M^{th} middle status chrominance components CM₁′, CM₂′, . . . , and CM′_{M}. To obtain the first through M^{th} middle status chrominance components CM₁′, CM₂′, . . . , and CM′_{M}, the middle status chrominance component producer 10 may linearly combine the first through M^{th} input chrominance components Cl₁, Cl₂, . . . , and Cl_{M} according to Equation 1 or 2. For example, when the first through third input chrominance components Cl₁, Cl₂, and Cl₃ are Rᵢ, Gᵢ, and Bᵢ, respectively, and the first through third middle status chrominance components CM₁′, CM₂′, and CM₃′ are C₁, M₁, and Y₁, respectively, the middle status chrominance component producer 10 can produce the first through third middle status chrominance components CM₁′, CM₂′, and CM₃′ by linearly combining the first through third input chrominance components Cl₁′, Cl₂, and Cl₃ according to Equation 1 or 3.

When the first through third input chrominance components Cl₁, Cl₂, and Cl₃ are Rᵢ, Gᵢ, and Bᵢ, respectively, and the first through third middle status chrominance components CM₁′, CM₂′, and CM₃′ are R₁, G₁, and B₁, respectively, the middle status chrominance component producer 10 can produce the first through third middle status chrominance components CM₁′, CM₂′, and CM₃′ by linearly combining the first through third input chrominance components Cl₁, Cl₂, and Cl₃ according to Equation 1.

The middle status chrominance component producer 10 linearly combines the first through M^{th} middle status chrominance components CM₁′, CM₂′, and CM_{M}′ and outputs the result of the linear combination as first through N^{th} middle status chrominance components CM₁, CM₂, . . . , and CM_{N}. To obtain the first through N^{th} middle status chrominance components CM₁, CM₂, . . . , and CM_{N}, the first through M^{th} middle status chrominance components CM₁′, CM₂′, and CM_{M}′ are linearly combined in the same manner as when the first through M^{th} input chrominance components Cl₁, Cl₂, . . . , and Cl_{M} are linearly combined to obtain the first through N^{th} middle status chrominance components CM₁, CM₂, . . . , and CM_{N}. Therefore, a description of the process of linearly combining the first through M^{th} middle status chrominance components CM₁′, CM₂′, . . . , and CM_{M}′ is omitted.

In the present embodiment, the middle status chrominance component generator 42 in FIG. 6 (or the middle status chrominance component generator 66 in FIG. 8) generates the first through M^{th} middle status chrominance components CM₁′, CM₂′, and CM_{M}′ by linearly combining the first through M^{th} input chrominance components Cl₁, Cl₂, . . . , and Cl_{M} using coefficients input from the coefficient group determiner 40 (64) and generates the first through N^{th} middle status chrominance components CM₁, CM₂, . . . , and CM_{N} by linearly combining the first through M^{th} middle status chrominance components CM₁′, CM₂′, . . . , and CM_{M}′.

After operation 20, in operation 22, the chrominance component compensator 12 of FIG. 4 relatively differently adjusts the luminance levels of the first through N^{th} middle status chrominance components according to the degrees to which the first through N^{th} middle status chrominance components input from the middle status chrominance component producer 10 contribute to representing the single color and outputs the first through N^{th} middle status chrominance components having the adjusted luminance levels as color-compensated first through N^{th} middle status chrominance components.

FIG. 10 is a block diagram of an embodiment 12A of the present invention of the chrominance component compensator 12 of FIG. 4, including a level generator 100, a first luminance level checker 102, and a first luminance level adjuster 104.

Although not shown, the chrominance component compensator 12 may include only the first luminance level checker 102 and the first luminance level adjuster 104.

The first luminance level checker 102 checks whether a luminance level of a selected contribution chrominance component input via an input node IN5 is lower than a first predetermined level and a luminance level of a single color input via an input node IN6 is higher than the first predetermined level and outputs the check results to the first luminance level adjuster 104. Here, the selected contribution chrominance component refers to one of the first through N^{th} middle status chrominance components which most greatly contributes to representing the single color. The first predetermined level may be set to a maximum luminance level of the selected contribution chrominance component.

The first luminance level adjuster 104 adjusts the luminance level of the selected contribution chrominance component in response to the check results of the first luminance level checker 102, reflects the adjustment result to adjust luminance levels of unselected contribution chrominance components, and outputs the first through N^{th} middle status chrominance components having the adjusted luminance levels as color-compensated first through N^{th} middle status chrominance components. Here, the unselected contribution chrominance components refer to middle status chrominance components which are obtained by removing the selected contribution chrominance component from the first through N^{th} middle status chrominance components and which greatly contribute to representing the single color according to the order of second, third, . . . , and N^{th} contribution chrominance components. In other words, following the selected contribution chrominance component, the second contribution chrominance component greatly contributes to representing the single color.

According to another aspect of the present invention, as shown in FIG. 10, the chrominance component compensator 12A may further include the level generator 100.

The level generator 100 generates the first predetermined level using the luminance level of the selected contribution chrominance component input via the input node IN5, the luminance level of the single color input via the input node IN6, and a weight input via an input node IN7 and outputs the generated first predetermined level to the first luminance level checker 102 and the first luminance level adjuster 104. Here, the weight refers to a degree to which each of the first through N^{th} middle status chrominance components contributes to representing the single color and may be input from an external source via the input node IN7 or may be obtained by the level generator 100 using the first through N^{th} middle status chrominance components. For example, the level generator 100 can generate the first predetermined level using Equation 6:

$${X}_{th} = Region \frac{{D}_{Yx}}{{D}_{Yt}} \qquad ( 6 )$$

wherein Xₜₕ denotes the first predetermined level, Region denotes the weight, D_{Yx} denotes the luminance level of the selected contribution chrominance component, and D_{Yt} denotes the luminance level of the single color.

The first luminance level adjuster 104 of FIG. 10 may include a greater chrominance component compensator 110 and a smaller chrominance component compensator 112.

If the first luminance level checker 102 checks that the luminance level of the selected contribution chrominance component input via the input node IN5 is lower than the first predetermined level and the luminance level of the single color input via the input node IN6 is greater than the first predetermined level, the greater chrominance component compensator 110 increases the luminance level of the selected contribution chrominance component so as to be equal to the first predetermined level and reduces luminance levels of unselected contribution chrominance components input via an input node IN8 by the increase amount of the luminance level of the selected contribution chrominance component. The selected and unselected contribution chrominance components having the luminance levels adjusted by the greater chrominance component compensator 110 are output via an output node OUT6.

For example, when the luminance level of the selected contribution chrominance component is lower than the first predetermined level and the luminance level of the single color is higher than the first predetermined level, the greater chrominance component compensator 110 may adjust the luminance levels of the selected and unselected contribution chrominance components using Equation 7:

$$x2 = x1 + ( max - x1 ) Region \\ y2 = \frac{y1 - max \times {x}_{th} \times Region}{1 - {x}_{th} \times Region} \qquad ( 7 )$$

wherein x2 denotes the adjusted luminance level of the selected contribution chrominance component, x1 denotes the unadjusted luminance level of the selected contribution chrominance component, y2 denotes the adjusted luminance levels of the unselected contribution chrominance components, y1 denotes the unadjusted luminance levels of the unselected contribution chrominance components, and max denotes a maximum luminance level each middle status chrominance component may have, for example, “255”.

If it is determined from the check result of the first luminance level checker 102 that the luminance level of the selected contribution chrominance component input via the input node IN5 is lower than the first predetermined level and the luminance level of the single color input via the input node IN6 is less than or equal to the first predetermined level, the smaller chrominance component compensator 112 increases or reduces the luminance level of the selected contribution chrominance component so as to be equal to the luminance level of the single color, and reduces or increases the luminance levels of the unselected contribution chrominance components input via the input node IN8 by the increment or reduction amount of the luminance level of the selected contribution chrominance component.

For example, when the luminance level of the selected contribution chrominance component is less than the first predetermined level and the luminance level of the single color is less than or equal to the first predetermined level, the smaller chrominance component compensator 112 operates as follows. In other words, the smaller chrominance component compensator 112 increases the luminance level of the selected contribution chrominance component so as to be equal to the luminance level of the single color and reduces the luminance levels of the unselected contribution chrominance components by or in proportion to the increased amount of the luminance level of the selected contribution chrominance component. Alternatively, the smaller chrominance component compensator 112 may reduce the luminance level of the selected contribution chrominance component so as to be equal to the luminance level of the single color and increases the luminance levels of the unselected contribution chrominance components by or in proportion to the reduction amount of the luminance level of the selected contribution chrominance component.

The selected and unselected contribution chrominance components having the luminance levels adjusted by the smaller chrominance component compensator 112 are output via an output node OUT7.

For example, when the luminance level of the selected contribution chrominance component is less than the first predetermined level and the luminance level of the single color is lower than or equal to the first predetermined level, the smaller chrominance component compensator 112 adjusts the luminance levels of the selected and unselected contribution chrominance components according to Equation 8:

$$x2 = \frac{x1 + x1 \times ( 1 - {x}_{th} ) \times Region}{{x}_{th}} \\ y2 = y1 - {x}_{th} \times {x}_{2} \times Region . \qquad ( 8 )$$

The first luminance level adjuster 104 of FIG. 10 adjusts the luminance levels of the unselected contribution luminance levels according to priority of the degrees to which the unselected contribution chrominance components contribute to representing the single color. For example, the greater chrominance component compensator 110 reduces the luminance levels of the unselected contribution chrominance components by the increase amount of the luminance level of the selected contribution chrominance component, according to the order of the second, third, . . . , and N^{th} contribution chrominance components. The smaller chrominance component compensator 112 reduces or increases the luminance levels of the unselected contribution chrominance components by the increment or reduction amount of the luminance level of the selected contribution chrominance component according to the order of the second, third, . . . , and N^{th} contribution chrominance components.

In a case where the chrominance component compensator 12 of FIG. 4 compensates the first through N^{th} middle status chrominance components, the color saturations of the first through N^{th} middle status chrominance components become maximized, which may contribute to maximizing color gamut.

In an embodiment of the present invention, the multiple color transformation apparatus for the image may include only the middle status chrominance component producer 10 and the chrominance component compensator 12. In this case, the multiple color transformation method for an image illustrated in FIG. 5 may include only operations 20 and 22.

In another embodiment of the present invention, as shown in FIG. 4, the multiple color transformation apparatus for the image may include the middle status chrominance component producer 10, the chrominance component compensator 12, and the luminance component compensator 14. In this case, the multiple color transformation method for an image may include operations 20, 22, and 24, as illustrated in FIG. 5.

After operation 22, in operation 24, the luminance component compensator 14 of FIG. 4 compensates the luminance levels of the first through N^{th} middle status chrominance components color-compensated by a difference between the luminance level of the single color to be represented by the color-compensated first through N^{th} middle status chrominance components input from the chrominance component compensator 12 and a second predetermined level, that is, a compensation level, and outputs the compensation results via the output node OUT1. Here, the second predetermined level may be a luminance level of a color, which is represented by the first through M^{th} input chrominance components, or may be a luminance level which is determined in advance and is desired by a user.

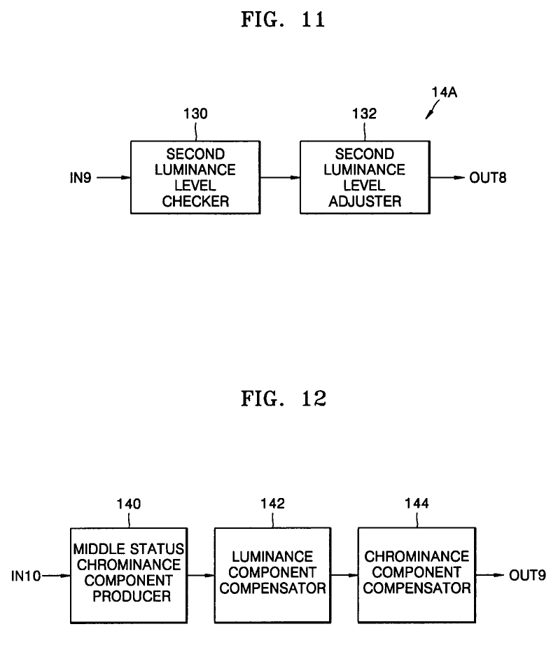

FIG. 11 is a block diagram of an embodiment 14A of the present invention of the luminance component compensator 14 of FIG. 4, including a second luminance level checker 130 and a second luminance level adjuster 132.

The second luminance level checker 130 checks whether a difference between the luminance level of the single color to be represented by the color-compensated first through N^{th} middle status chrominance components input from the chrominance component compensator 12 via an input node IN9 and the second predetermined level exists and outputs the check result to the second luminance level adjuster 132. For example, when it is assumed that the second predetermined level corresponds to the luminance level of the color represented by the first through M^{th} input chrominance components, the second luminance level checker 130 checks whether the difference between the luminance level of the single color to be represented by the color-compensated first through N^{th} middle status chrominance components and the second predetermined level exists, according to the chrominance components using Equation 9:
dY_{—}x[i]=sx[i]−dy[i] (9)

wherein, dy[i] denotes luminance levels of color-compensated middle status chrominance components corresponding to an i^{th} (1≦i≦M) input chrominance component of the color-compensated first through N^{th} middle status chrominance components, sx[i] denotes a luminance level of the i^{th} input chrominance component, and dY_x[i] denotes differences between the luminance level of the i^{th} input chrominance component and the luminance levels of the color-compensated middle status chrominance components corresponding to the i^{th} input chrominance component. For example, when the first input chrominance component is Rᵢ and the color-compensated first through N^{th} middle status chrominance components are R₂, G₂, B₂, C₂, M₂, and Y₂, dy[i] denotes luminance levels of R₂, M₂, and Y₂ corresponding to the first input chrominance component Rᵢ. In a similar manner, when the first input chrominance component is Gᵢ and the color-compensated first through N^{th} middle status chrominance components are R₂, G₂, B₂, C₂, M₂, and Y₂, dy[i] denotes luminance levels of G₂, Y₂, and C₂ corresponding to the first input chrominance component Gᵢ. When the first input chrominance component is Bᵢ and the color-compensated first through N^{th} middle status chrominance components are R₂, G₂, B₂, C₂, M₂, and Y₂, dy[i] denotes luminance levels of B₂, M₂, and C₂ corresponding to the first input chrominance component Bᵢ.

If it is determined from the check result of the second luminance level checker 130 that the difference between the luminance level of the single color to be represented by the color-compensated first through N^{th} middle status chrominance components and the second predetermined level exists, i.e., dY_x is not “0”, the second luminance level adjuster 132 adjusts the luminance level of the single color to be represented by the color-compensated first through N^{th} middle status chrominance components and outputs the adjustment result via an output node OUT8. Here, the second luminance level adjuster 132 may adjust the luminance level of the single color to be represented by the color-compensated first through N^{th} middle status chrominance components according to the degrees to which the color-compensated first through N^{th} middle status chrominance components contribute to representing the single color, i.e., the contribution priorities of the color-compensated first through N^{th} middle status chrominance components. For example, the second luminance level adjuster 132 adds a value, which is obtained using Equation 10 (below), to the luminance levels of the color-compensated middle status chrominance components corresponding to the i^{th} input chrominance component until dY_x[i] becomes “0”:
dY_{—}x[i]×Regionⱼ (10)
wherein Regionⱼ denotes a degree to which a j^{th} (1≦j≦N) middle status chrominance component of the color-compensated first through N^{th} middle status chrominance components contributes to representing the single color which is to be represented by the color-compensated first through N^{th} middle status chrominance components.

FIG. 12 is a block diagram of a multiple color transformation apparatus for an image according to another embodiment of the present invention. The multiple color transformation apparatus in FIG. 12 includes a middle status chrominance component producer 140, a luminance component compensator 142, and a chrominance component compensator 144.

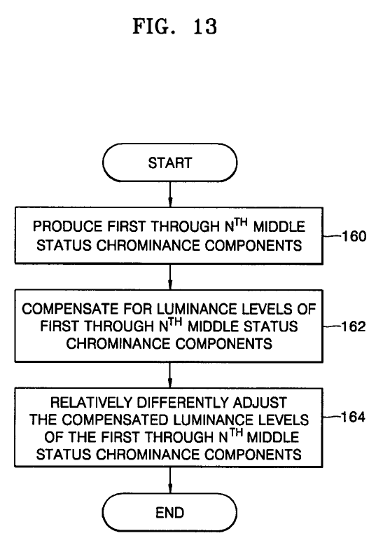

FIG. 13 is a flowchart of a multiple color transformation method for an image according to another embodiment of the present invention. The method in FIG. 13 includes producing first through N^{th} middle status chrominance components and compensating for luminance levels of the first through N^{th} middle status chrominance components (operations 160 and 162) and relatively differently adjusting the compensated luminance levels of the first through N^{th} middle status chrominance components (operation 164).

The middle status chrominance component producer 140 in FIG. 12 is similar to and performs a similar function as the middle status chrominance component producer 10 in FIG. 4. Therefore, a detailed description thereof is omitted. In addition, operation 160 in FIG. 13 is similar to operation 20 in FIG. 5. Therefore, a detailed description thereof is omitted.

In another embodiment of the present invention, the multiple color transformation apparatus may include only the middle status chrominance component producer 140 and the luminance component compensator 142.

In this case, after operation 160, the luminance component compensator 142 in FIG. 12 compensates the luminance levels of the first through N^{th} middle status chrominance components by the difference between the luminance level of the single color to be represented by the first through N^{th} middle status chrominance components input from the middle status chrominance component producer 140 and the second predetermined level and outputs the compensation result (operation 162).

The embodiment 14A in FIG. 11 can be an embodiment of the luminance component compensator 142 in FIG. 12. In this case, the second luminance level checker 130 of FIG. 11 checks whether the difference between the luminance level of the single color to be represented by the first through N^{th} middle status chrominance components input from the middle status chrominance component producer 140 via the input node IN9 and the second predetermined level exists and outputs the check result to the second luminance level adjuster 132. For example, it is assumed that the second predetermined level corresponds to the luminance level of the color represented by the first through M^{th} input chrominance components, the second luminance level checker 130 checks whether the difference between the luminance level of the single color to be represented by the first through N^{th} middle status chrominance components and the second predetermined level exists, according to the chrominance components, using Equation 11:
dY_{—}x′[i]=sx[i]−dy′[i] (11)
wherein dy′[i] denotes the luminance levels of the middle status chrominance components corresponding to the i^{th} input chrominance component of the first through N^{th} middle status chrominance components, and dY_x′[i] denotes differences between the luminance level of the i^{th} input chrominance component and luminance levels of the middle status chrominance components corresponding to the i^{th} input chrominance component. For example, it is assumed that the first input chrominance component is referred to as Rᵢ, dy′[i] denotes luminance levels of R₁, M₁, and Y₁ corresponding to the first input chrominance component Rᵢ of R₁, G₁, B₁, C₁, M₁, and Y₁.

If it is perceived based on the check result of the second luminance level checker 130 that the difference between the luminance level of the single color to be represented by the first through N^{th} middle status chrominance components and the second predetermined level exists, i.e., dY_x′ is not “0”, the second luminance level adjuster 132 adjusts the luminance level of the single color to be represented by the first through N^{th} middle status chrominance components and outputs the adjustment result via the output node OUT8. Here, the second luminance level adjuster 132 adjusts the luminance level of the single color to be represented by the first through N^{th} middle status chrominance components according to the degrees to which the first through N^{th} middle status chrominance components contribute to representing the single color, i.e., the contribution priorities of the first through N^{th} middle status chrominance components. For example, the second luminance level adjuster 132 adds a value, which is obtained using Equation 12, to the luminance levels of the middle status chrominance components corresponding to the i^{th} input chrominance component until dY_x′[i] becomes “0”:
dY_x′[i]×Region′ⱼ (12)
wherein Region′ⱼ denotes the degree to which the j^{th} middle status chrominance component of the first through N^{th} middle status chrominance components contributes to representing the single color, which is to be represented by the first through N^{th} middle status chrominance components. Here, 1−j≦N.

In other words, the luminance component compensator 142 in FIG. 12 and the luminance compensator 14 in FIG. 4 compensate for luminance levels according to the same principle, except that the components whose luminance levels are compensated for by the luminance component compensator 142 in FIG. 12 are the first through N^{th} middle status chrominance components input from the middle status component producers 140 and the components whose luminance levels are compensated for by the luminance component compensator 14 are the chrominance-compensated first through N^{th} middle status chrominance components input from the chrominance component compensator 12.

In another embodiment of the present invention, the multiple color transformation apparatus may further include the chrominance component compensator 144 in addition to the middle status chrominance component producer 140 and the luminance component compensator 142, as illustrated in FIG. 12. In this case, the multiple color transformation method for an image in FIG. 13 may further include operation 164 as well as operations 160 and 162.

In this case, after operation 162, the chrominance component compensator 144 in FIG. 12 relatively differently adjusts the compensated luminance levels of the first through N^{th} middle status chrominance components input from the luminance component compensator 142 according to the degrees to which the luminance-compensated first through N^{th} middle status chrominance components contribute to representing the single color, and outputs the first through N^{th} middle status chrominance components having the adjusted luminance levels via an output node OUT9 (operation 164).

In other words, the chrominance component compensator 144 in FIG. 12 and the chrominance component compensator 12 in FIG. 4 provide the same function under the same principle, except that the input to the chrominance component compensator 144 in FIG. 12 is provided by the luminance component compensator 142, and the input to the chrominance component compensator 12 in FIG. 4 is provided by the middle status chrominance component producer 10. The embodiment 12A in FIG. 10 for the chrominance component compensator 12 in FIG. 4 may apply to the chrominance component compensator 144 in FIG. 12.

The embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

As described above, a multiple color transformation apparatus and method for an image, according to the embodiments of the present invention, can transform M input chrominance components into N (where N is greater than or equal to M) chrominance components to maximize a luminance and color saturation of an image display device. In particular, first through M^{th} input chrominance components can be compensated using at least one of coefficient groups, which are determined by the middle status chrominance component producer 10A of FIG. 6 or 10B of FIG. 8 in consideration of a process capability. Thus, deterioration of image quality or changes in color occurring due to a process of manufacturing the image display device can be minimized. Also, the luminance chrominance component compensator 14 can prevent loss of luminance resulting from multiple color transformation.

Although a few embodiments of the present invention have been shown and described, it would be appreciated by those skilled in the art that changes may be made in these embodiments without departing from the principles and spirit of the invention, the scope of which is defined in the claims and their equivalents.

1. A multiple color transformation apparatus for an image comprising pixels, comprising:
a middle status chrominance component producer which linearly combines first through M^{th} (where M is a positive integer greater than or equal to “3”) input chrominance components to represent a color of each of the pixels to thereby produce first through N^{th} (where N is greater than or equal to M) middle status chrominance components; and
a chrominance component compensator which relatively differently adjusts luminance levels of the first through N^{th} middle status chrominance components according to degrees to which the first through N^{th} middle status chrominance components contribute to representing a single color of the image and outputs the first through N^{th} middle status chrominance components having the adjusted luminance levels as color-compensated first through N^{th} middle status chrominance components.

2. The multiple color transformation apparatus of claim 1, wherein the middle status chrominance component producer produces first through M^{th} middle status chrominance components by linearly combining the first through M^{th} input chrominance components and produces the first through N^{th} middle status chrominance components by linearly combining the first through M^{th} middle status chrominance components.

3. The multiple color transformation apparatus of claim 2, wherein the middle status chrominance component producer comprises:
a coefficient group determiner which determines a coefficient group; and
a middle status chrominance component generator which generates the first through N^{th} middle status chrominance components from the first through M^{th} input chrominance components using the determined coefficient group.

4. The multiple color transformation apparatus of claim 3, wherein the middle status chrominance component generator generates the first through M^{th} middle status chrominance components among the first through N^{th} middle status chrominance components according to:
$$[ \begin{matrix}{CM}_{1} \\ {CM}_{2} \\ ⋮ \\ {CM}_{M}\end{matrix} ] = {COEFF}_{1} [ \begin{matrix}{CI}_{1} \\ {CI}_{2} \\ ⋮ \\ {CI}_{M}\end{matrix} ]$$
wherein Cl₁, Cl₂, . . . , and Cl_{M} denote the first through M^{th} input chrominance components, respectively, CM₁, CM₂, . . . , and CM_{M} denote the first through M^{th} middle status chrominance components, respectively, and COEFF₁ denotes a first one of the coefficient groups determined in the coefficient group determiner.

5. The multiple color transformation apparatus of claim 4, wherein the middle status chrominance component generator generates the (M+1)^{th} through N^{th} middle status chrominance components among the first through N^{th} middle status chrominance components according to:
$$[ \begin{matrix}{CM}_{M + 1} \\ {CM}_{M + 2} \\ ⋮ \\ {CM}_{N}\end{matrix} ] = {COEFF}_{2} [ \begin{matrix}{CI}_{1} \\ {CI}_{2} \\ ⋮ \\ {CI}_{M}\end{matrix} ]$$
wherein CM_{M+1}, CM_{M+2}, . . . , and CM_{N} denote the (M+l)th through N^{th} middle status chrominance components, respectively, and COEFF₂ denotes a second one of the coefficient groups determined in the coefficient group determiner.

6. The multiple color transformation apparatus of claim 3, wherein the middle status chrominance component producer further comprises:
a scaling necessity checker which checks whether a user has requested scaling of at least one of the first through N^{th} middle status chrominance components and generates a check result;
a scaling ratio determiner which determines a scaling ratio in response to the generated check result of the scaling necessity checker; and
a scaler which scales at least one of the first through N^{th} middle status chrominance components using the determined scaling ratio in response to the check result of the scaling necessity checker.

7. The multiple color transformation apparatus of claim 6, wherein the scaling ratio determiner determines the scaling ratio to be complementary to a grayness of the first through M^{th} input chrominance components in response to the check result of the scaling necessity checker.

8. The multiple color transformation apparatus of claim 3, wherein the middle status chrominance component producer further comprises:
a scaling necessity checker which checks whether a user has requested scaling of at least one of the first through N^{th} middle status chrominance components and generates a check result; and
a scaling ratio determiner which determines a scaling ratio in response to the generated check result of the scaling necessity checker,
wherein the coefficient group determiner uses the scaling ratio in response to the check result of the scaling necessity checker to determine the coefficient group.

9. The multiple color transformation apparatus of claim 6, wherein the middle status chrominance component producer further comprises:
a threshold luminance level checker which checks whether at least one of luminance levels of the scaled first through N^{th} middle status chrominance components is outside of a substantial threshold luminance level; and
a threshold luminance level adjuster which adjusts the luminance levels of the scaled first through N^{th} middle status chrominance components, which are outside of the substantial threshold luminance level, to be within the threshold luminance level, in response to the check result from the threshold luminance level checker.

10. The multiple color transformation apparatus of claim 2, wherein the chrominance component compensator comprises:
a first luminance level checker which checks whether a luminance level of a selected one of the contribution chrominance components is lower than a first predetermined level and a luminance level of the single color is greater than the first predetermined level and generates a check result; and
a first luminance level adjuster which adjusts the luminance level of the selected contribution chrominance component in response to the check result of the first luminance level checker, the adjusted luminance level to adjust a luminance level of unselected ones of the contribution chrominance components,
wherein the selected contribution chrominance component corresponds to a one of the first through N^{th} middle status chrominance components which most greatly contributes to representing the single color and the unselected contribution chrominance components correspond to the first through N^{th} middle status chrominance components which are not the selected contribution chrominance component.

11. The multiple color transformation apparatus of claim 10, wherein the first predetermined level corresponds to a maximum luminance level of the selected contribution chrominance component.

12. The multiple color transformation apparatus of claim 10, wherein the chrominance component compensator further comprises:
a level generator which generates the first predetermined level using the luminance level of the selected contribution chrominance component, the luminance level of the single color, and a weight and outputs the generated first predetermined level to the first luminance level checker,
wherein the weight is a degree to which each of the first through N^{th} middle status chrominance components contributes to representing the single color.

13. The multiple color transformation apparatus of claim 12, wherein the level generator generates the first predetermined level according to:
$${x}_{th} = Region \frac{{D}_{Yx}}{{D}_{Yt}}$$
wherein xₜₕ denotes the first predetermined level, Region denotes the weight, D_{Yx} denotes the luminance level of the selected contribution chrominance component, and D_{Yt} denotes the luminance level of the single color.

14. The multiple color transformation apparatus of claim 10, wherein the first luminance level adjuster comprises:
a greater chrominance component compensator which, if determined from the check result of the first luminance level checker that the luminance level of the selected contribution chrominance component is lower than the first predetermined level and the luminance level of the single color is greater than the first predetermined level, increases the luminance level of the selected contribution chrominance component to be equal to the first predetermined level and reduces the luminance level of the unselected contribution chrominance components by an amount of increase of the luminance level of the selected contribution chrominance component; and
a smaller chrominance component compensator which, if determined from the check result of the first luminance level checker that the luminance level of the selected contribution chrominance component is lower than the first predetermined level and the luminance level of the single color is less than or equal to the first predetermined level, increases or reduces the luminance level of the selected contribution chrominance component to be equal to the luminance level of the single color, and reduces or increases the luminance levels of the unselected contribution chrominance components by an amount of increase or decrease of the luminance level of the selected contribution chrominance component.

15. The multiple color transformation apparatus of claim 12, wherein the first luminance level adjuster adjusts the luminance levels of the unselected contribution chrominance components according to priorities of degrees to which the unselected contribution chrominance components contribute to representing the single color.

16. The multiple color transformation apparatus of claim 14, wherein when the luminance level of the selected contribution chrominance component is lower than the first predetermined level and the luminance level of the single color is greater than the first predetermined level, the greater chrominance component compensator adjusts the luminance levels of the selected and unselected contribution chrominance components according to:
$$x2 = x1 + ( max - x1 ) Region$$
$$y2 = \frac{y1 - max \times {x}_{th} \times Region}{1 - {x}_{th} \times Region}$$
wherein x2 denotes the adjusted luminance level of the selected contribution chrominance component, x1 denotes the unadjusted luminance level of the selected contribution chrominance component, y2 denotes the adjusted luminance levels of the unselected contribution chrominance components, y1 denotes unadjusted luminance levels of the unselected contribution chrominance components, xₜₕ denotes the first predetermined level which is expressed as
$${x}_{th} = Region \frac{{D}_{Yx}}{{D}_{Yt}}$$
where D_{Yx} denotes the luminance level of the selected contribution chrominance component and D_{Yt} denotes the luminance level of the single color, max denotes a maximum luminance level of the middle status chrominance components and Region denotes a weight.

17. The multiple color transformation apparatus of claim 14, wherein when the luminance level of the selected contribution chrominance component is lower than the first predetermined level and the luminance level of the single color is less than or equal to the first predetermined level, the smaller chrominance component compensator adjusts the luminance levels of the selected and unselected contribution chrominance components according to:
$$x2 = \frac{x1 + x1 \times ( 1 - {x}_{th} ) \times Region}{{x}_{th}}$$
$$y2 = y1 - {x}_{th} \times {x}_{2} \times Region$$
wherein x2 denotes the adjusted luminance level of the selected contribution chrominance component, x1 denotes the unadjusted luminance level of the selected contribution chrominance component, y2 denotes the adjusted luminance levels of the unselected contribution chrominance components, y1 denotes the unadjusted luminance levels of the unselected contribution chrominance components, xₜₕ denotes the first predetermined level which is expressed as:
$${x}_{th} = Region \frac{{D}_{Yx}}{{D}_{Yt}} ,$$
where D_{Yx} denotes the luminance level of the selected contribution chrominance component and D_{Yt} denotes the luminance level of the single color, and Region denotes a weight.

18. The multiple color transformation apparatus of claim 2, further comprising:
a luminance component compensator which compensates the luminance levels of the color-compensated first through N^{th} middle status chrominance components by a difference between a luminance level of the single color to be represented by the color-compensated first through N^{th} middle status chrominance components and a compensation level.

19. The multiple color transformation apparatus of claim 18, wherein the luminance component compensator comprises:
a luminance level checker which checks whether the difference between the luminance level of the single color to be represented by the color-compensated first through N^{th} middle status chrominance components and the compensation level exists; and
a luminance level adjuster which adjusts the luminance levels of the color-compensated first through N^{th} middle status chrominance components in response to the checking of the luminance level checker.

20. The multiple color transformation apparatus of claim 19, wherein the compensation level corresponds to a luminance level of a color that is to be represented by the first through M^{th} input chrominance components.

21. The multiple color transformation apparatus of claim 19, wherein the compensation level is a luminance level that is pre-determined and is desired by a user.

22. The multiple color transformation apparatus of claim 19, wherein the luminance level checker checks, for each of the first through M^{th} input chrominance components, whether the difference between the luminance level of the single color and the compensation level exists according to:
dY_{—}x[i]=sx[i]−dy[i]
wherein, dy[i] denotes luminance levels of color-compensated middle status chrominance components corresponding to an i^{th} (1≦i≦M) input chrominance component of the color-compensated first through N^{th} middle status chrominance components, sx[i] denotes a luminance level of the i^{th} input chrominance component, and dY_x[i] denotes differences between the luminance level of the i^{th} input chrominance component and the luminance levels of the color-compensated middle status chrominance components corresponding to the i^{th} input chrominance component.

23. A multiple color transformation method for an image, comprising:
producing first through N^{th} middle status chrominance components by linearly combining first through M^{th} (where M is a positive integer greater than or equal to 3 and N is greater than or equal to M) input chrominance components for representing a color of each of pixels of the image; and
relatively differently adjusting luminance levels of the first through N^{th} middle status chrominance components according to degrees to which the first through N^{th} middle status chrominance components contribute to representing a single color of the image and determining the first through N^{th} middle status chrominance components having the adjusted luminance levels as color-compensated first through N^{th} middle status chrominance components.

24. The multiple color transformation method of claim 23, wherein the producing of the first through N^{th} middle status chrominance components comprises producing first through M^{th} middle status chrominance components by linearly combining the first through M^{th} input chrominance components and providing the first through N^{th} middle status chrominance components by linearly combining the first through M^{th} middle status chrominance components.

25. The multiple color transformation method of claim 24, further comprising:
compensating luminance levels of the color-compensated first through N^{th} middle status chrominance components by a difference between a luminance level of the single color to be represented by the color-compensated first through N^{th} middle status chrominance components and a compensation level.

26. A multiple color transformation apparatus for an image, comprising:
a middle status chrominance component producer which linearly combines first through M^{th} (where M is a positive integer greater than or equal to “3”) input chrominance components to represent a color of each of pixels of the image to produce first through N^{th} (where N is greater than or equal to M) middle status chrominance components; and
a luminance component compensator which compensates luminance levels of the first through N^{th} middle status chrominance components by a difference between a luminance level of a single color to be represented by the first through N^{th} middle status chrominance components and a compensation level.

27. The multiple color transformation apparatus of claim 26, further comprising a chrominance component compensator that relatively differently adjusts the compensated luminance levels of the first through N^{th} middle status chrominance components according to the degrees to which the luminance-compensated first through N^{th} middle status chrominance components contribute to representing the single color.

28. The multiple color transformation apparatus of claim 27, wherein the luminance component compensator comprises:
a luminance level checker which checks whether the difference between the luminance level of the single color to be represented by the first through N^{th} middle status chrominance components and the compensation level exists; and
a luminance level adjuster which adjusts the luminance levels of the first through N^{th} middle status chrominance components in response to the checking of the luminance level checker.

29. The multiple color transformation apparatus of claim 28, wherein the compensation level corresponds to a luminance level of a color which is to be represented by the first through M^{th} input chrominance components.

30. The multiple color transformation apparatus of claim 28, wherein the compensation level is a luminance level which is pre-determined and is desired by a user.

31. The multiple color transformation apparatus of claim 28, wherein the luminance level checker checks, for each of the first through M^{th} input chrominance components, whether the difference between the luminance level of the single color and the compensation level exists according to:
dY_{—}x′[i]=sx[i]−dy′[i
wherein, dy′[i] denotes luminance levels of middle status chrominance components corresponding to an i^{th} (1≦i≦M) input chrominance component of the first through N^{th} middle status chrominance components, sx[i] denotes a luminance level of the i^{th} input chrominance component, and dY_x′[i] denotes differences between the luminance level of the i^{th} input chrominance component and the luminance levels of the middle status chrominance components corresponding to the i^{th} input chrominance component.

32. A multiple color transformation method for an image, comprising:
linearly combining first through M^{th} (where M is a positive integer greater than or equal to “3”) input chrominance components for representing a color of each of pixels of the image to produce first through N^{th} (where N is greater than or equal to M) middle status chrominance components; and
compensating luminance levels of the first through N^{th} middle status chrominance components by a difference between a luminance level of a single color to be represented by the first through N^{th} middle status chrominance components and a compensation level.

33. The multiple color transformation method of claim 32, further comprising relatively differently adjusting the compensated luminance levels of the first through N^{th} middle status chrominance components according to degrees to which the luminance-compensated first through N^{th} middle status chrominance components contribute to representing the single color.

34. A computer readable recording medium having embodied thereon a computer program for a multiple color transformation method for an image, the method comprising:
producing first through N^{th} middle status chrominance components by linearly combining first through M^{th} (where M is a positive integer greater than or equal to 3 and N is greater than or equal to M) input chrominance components for representing a color of each of pixels of the image; and
relatively differently adjusting luminance levels of the first through N^{th} middle status chrominance components according to degrees to which the first through N^{th} middle status chrominance components contribute to representing a single color of the image and determining the first through N^{th} middle status chrominance components having the adjusted luminance levels as color-compensated first through N^{th} middle status chrominance components.

35. The computer readable recording medium of claim 34, wherein the producing of the first through N^{th} middle status chrominance components comprises producing first through M^{th} middle status chrominance components by linearly combining the first through M^{th} input chrominance components and providing the first through N^{th} middle status chrominance components by linearly combining the first through M^{th} middle status chrominance components.

36. The computer readable recording medium of claim 35, further comprising compensating luminance levels of the color-compensated first through N^{th} middle status chrominance components by a difference between a luminance level of the single color to be represented by the color-compensated first through N^{th} middle status chrominance components and a predetermined compensation level.

37. A computer readable recording medium having embodied thereon a computer program for a multiple color transformation method for an image, the method comprising:
linearly combining first through M^{th} (where M is a positive integer greater than or equal to “3”) input chrominance components for representing a color of each of pixels of the image to produce first through N^{th} (where N is greater than or equal to M) middle status chrominance components; and
compensating luminance levels of the first through N^{th} middle status chrominance components by a difference between a luminance level of a single color to be represented by the first through N^{th} middle status chrominance components and a compensation level.

38. The computer readable recording medium of claim 37, wherein the method further comprises relatively differently adjusting the compensated luminance levels of the first through N^{th} middle status chrominance components according to degrees to which the luminance-compensated first through N^{th} middle status chrominance components contribute to representing the single color.
